(19) United States
(12) Patent Application Publication
(10) Pub. No.: US 2017/0055001 A1
(43) Pub. Date: Feb. 23, 2017

(54) IMAGE ENCODING APPARATUS AND IMAGE DECODING APPARATUS

(71) Applicant: MITSUBISHI ELECTRIC CORPORATION, Tokyo (JP)

(72) Inventors: Takashi NISHITSUJI, Tokyo (JP); Katsuhiro KUSANO, Tokyo (JP); Hirofumi NISHIKAWA, Tokyo (JP)

(73) Assignee: MITSUBISHI ELECTRIC CORPORATION, Tokyo (JP)

(21) Appl. No.: 15/306,745

(22) PCT Filed: May 8, 2014
(86) PCT No.: PCT/JP2014/002433

§ 371 Date: Oct. 25, 2016

(51) Int. Cl. H04N 19/61; H04N 19/179; H04N 19/44; H04N 19/114

(52) U.S. Cl. CPC H04N 19/61; H04N 19/114; H04N 19/179; H04N 19/44

(57) ABSTRACT

An image encoding apparatus continues displaying even if some image data is missing and can reduce delay in reverse reproduction. The image encoding apparatus subjects a picture at the head of a GOP (Group of Picture) to intra-frame prediction encoding and the other pictures to inter-frame prediction encoding, for the other pictures, the image encoding apparatus subjects either top fields or bottom fields to intra-frame prediction encoding in a forward direction with respect to a display order, and the other fields to inter-frame prediction encoding in a reverse direction with respect to the display order.

### TECHNICAL FIELD

The present invention relates to an image encoding apparatus which sends out an encoded stream by encoding video image data, and an image decoding apparatus which decodes the encoded stream.

### BACKGROUND ART

A technology that encodes a video image by compression is widely employed. Typical examples of this technology include a method called MPEG-2 (Moving Picture Expert Group) employed by DVD (Digital Versatile Disk)-VIDEO, terrestrial digital television broadcasting (one-segment broadcasting) for mobile terminals, the H.264 method employed by Blu-ray Disk (registered trademark), and so on.

Patent Literature 1 listed below discloses an image encoding apparatus and an image decoding apparatus with which, in encoding the top field and bottom field of interlace-method image data independently of each other, if missing occurs in one field, decoding and displaying an image can be continued by using the other field instead. This literature also discloses a technique which, for an encoded bit stream consisting of an I picture (a picture subjected to intra-frame prediction encoding), a P picture, and a B picture (a picture encoded using inter-frame prediction), makes the inserting position of the I picture to be different between the top field and the bottom field, thereby reducing image display delay occurring at the time of system start up and channel switching.

### CITATION LIST

### Patent Literature

Patent Literature 1: JP 2003-304542

### SUMMARY OF INVENTION

### Technical Problem

According to the image encoding apparatus and the image decoding apparatus described in the above patent literature, the top field and the bottom field are encoded independently of each other. If data missing occurs in one field, this field can be replaced by the other field, so that displaying can be continued. In each field, however, image data of the individual fields are encoded in the forward direction with respect to the display order. To effect reverse reproduction, all images to be referred to must be decoded, causing the problem of display delay. In addition, the apparatuses described in the above patent literature treat interlace-method image data in which top fields and bottom fields exist. If data missing occurs in progressive-method image data, the apparatuses cannot continue displaying, and it takes time in reverse reproduction as well until displaying is effected.

The present invention has been made to solve the above problem, and has as its objective to provide an image encoding apparatus and an image decoding apparatus that can continue displaying and reduce delay in reverse reproduction even if missing occurs in some image data.

### Solution to Problem

An image encoding apparatus according to the present invention is an image encoding apparatus that encodes pictures constituted of top fields and bottom fields, and includes:

input image accumulating means for accumulating input images formed of a series of the pictures; and

encoding means for subjecting, among the input images outputted from the input image accumulating means, a head picture of a picture group formed of a predetermined number of pictures to intra-frame prediction encoding and the other pictures to inter-frame prediction encoding;

the encoding means serving to subject either the top fields or the bottom fields which constitute pictures other than the head picture, to inter-frame prediction encoding in a forward direction with respect to a display order, and the other fields to inter-frame prediction encoding in a reverse direction with respect to the display order.

An image encoding apparatus according to the present invention is an image encoding apparatus that encodes pictures constituted of frames, and includes:

input image accumulating means for accumulating input images formed of a series of the pictures; and

encoding means for subjecting, among the input images outputted from the input image accumulating means, a head picture of a picture group formed of a predetermined number of pictures to intra-frame prediction encoding and the other pictures to inter-frame prediction encoding with using the head picture as a reference image;

the encoding means serving to subject either even-number frames or odd-number frames which constitute pictures other than the head picture, to inter-frame prediction encoding in a forward direction with respect to a display order, and the other frames to inter-frame prediction encoding in a reverse direction with respect to the display order.

### Advantageous Effects of Invention

With an image encoding apparatus according to the present invention, either top fields or bottom fields, or either odd-number frames or even-number frames are subjected to inter-frame prediction encoding in a reverse direction with respect to the display order, so that display delay in reverse reproduction can be shortened. Also, if missing occurs in either the top fields or the bottom fields, or in either the odd-number frames or the even-number frames, missing-free fields or missing-free frame are used instead, enabling continuous displaying.

### BRIEF DESCRIPTION OF DRAWINGS

FIG. 1 is a configuration diagram illustrating an image encoding apparatus according to Embodiment 1.

FIG. 2 is a diagram illustrating an image encoding method according to Embodiment 1.

FIG. 3 is a diagram illustrating input image signals and an encoded stream according to Embodiment 1.

FIG. 4 is a flowchart illustrating a process stage of forward-direction encoding.

FIG. 5 is a flowchart illustrating a process stage of reverse-direction encoding.

FIG. 6 is a diagram illustrating an image encoding method according to Embodiment 2.

FIG. 7 is a diagram illustrating input image signals and an encoded stream according to Embodiment 2.

FIG. 8 is a configuration diagram illustrating an image decoding apparatus according to Embodiment 3.

FIG. 9 is a flowchart illustrating a decoding process stage in normal reproduction.

FIG. 10 is a flowchart illustrating a decoding process stage in reverse reproduction.

FIG. 11 is a diagram illustrating an image encoding method according to Embodiment 5.

FIG. 12 is a diagram illustrating input image signals and an encoded stream according to Embodiment 5.

FIG. 13 is a flowchart illustrating a process stage of forward-direction encoding.

FIG. 14 is a flowchart illustrating a process stage of reverse-direction encoding.

FIG. 15 is a diagram illustrating an image encoding method according to Embodiment 6.

FIG. 16 is a diagram illustrating input image signals and an encoded stream according to Embodiment 6.

FIG. 17 is a flowchart illustrating a decoding process stage in normal reproduction.

FIG. 18 is a flowchart illustrating a decoding process stage in reverse reproduction.

### DESCRIPTION OF EMBODIMENTS

### Embodiment 1

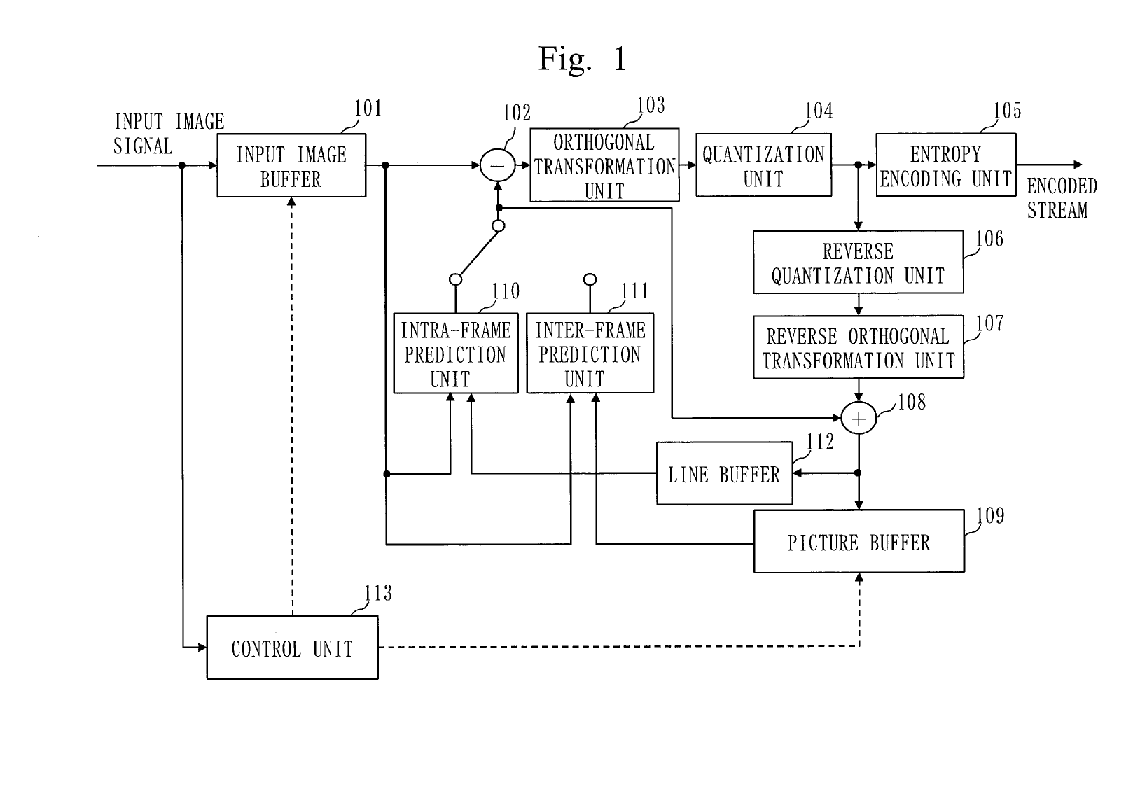

FIG. 1 is a configuration diagram illustrating an example of an image encoding apparatus according to Embodiment 1 of the present invention.

An input image buffer 101 outputs a 1-frame input image signal composed of a top field and a bottom field to an addition unit 102, an intra-frame prediction unit 110, and an inter-frame prediction unit 111, or discards the 1-frame input image signal, based on a control signal outputted from a control unit 113. The addition unit 102 outputs a difference between the input image signal outputted from the input image signal buffer 101 and a predicted image signal outputted from the intra-frame prediction unit 110 or inter-frame prediction unit 111, to an orthogonal transformation unit 103. The orthogonal transformation unit 103 orthogonally transforms a difference signal outputted from the addition unit 102, and outputs a transformation coefficient to a quantization unit 104. The quantization unit 104 quantizes the transformation coefficient outputted from the orthogonal transformation unit 103, and outputs a quantization coefficient to an entropy encoding unit 105 and a reverse quantization unit 106. The entropy encoding unit 105 encodes the quantization coefficient outputted from the quantization unit 104 and outputs an encoded stream to the outside of the image encoding apparatus.

The reverse quantization unit 106 reversely quantizes the quantization coefficient outputted from the quantization unit 104, and outputs a decoded transformation coefficient to a reverse orthogonal transformation unit 107. The reverse orthogonal transformation unit 107 reversely orthogonally transforms the decoded transformation coefficient outputted from the reverse quantization unit 106, and outputs a decoded difference signal to an addition unit 108. The addition unit 108 adds together the decoded difference signal outputted from the reverse orthogonal transformation unit and the predicted image signal outputted from the intra-frame prediction unit 110 or inter-frame prediction unit 111, and outputs a decoded image signal to a picture buffer 109 and a line buffer 112. The picture buffer 109 accumulates the decoded image signals outputted from the addition unit 108, and outputs to the inter-frame prediction unit 111 or discards the decoded image signals, based on the control signal inputted from the control unit 113. The line buffer 112 stores, among the decoded image signals outputted from the addition unit 108, data to be used for encoding in the intra-frame prediction unit 110, and outputs this data to the intra-frame prediction unit 110. The control unit 113 counts the frames of the image signals inputted from the outside of the image encoding apparatus and checks whether or not the input image signal of each frame is the head of a GOP (Group of Picture). If the input image signal is the head of the GOP, the control unit 113 intra-frame prediction encodes the input image signal. If the input image signal is not the head of the GOP, the control unit 113 outputs a signal instructing outputting or discarding of accumulated data, to the input image buffer 101 and picture buffer 109, so that either the top fields or the bottom fields are inter-frame prediction encoded in the forward direction with respect to the display order, and the other fields are inter-frame prediction encoded in the reverse direction with respect to the display order.

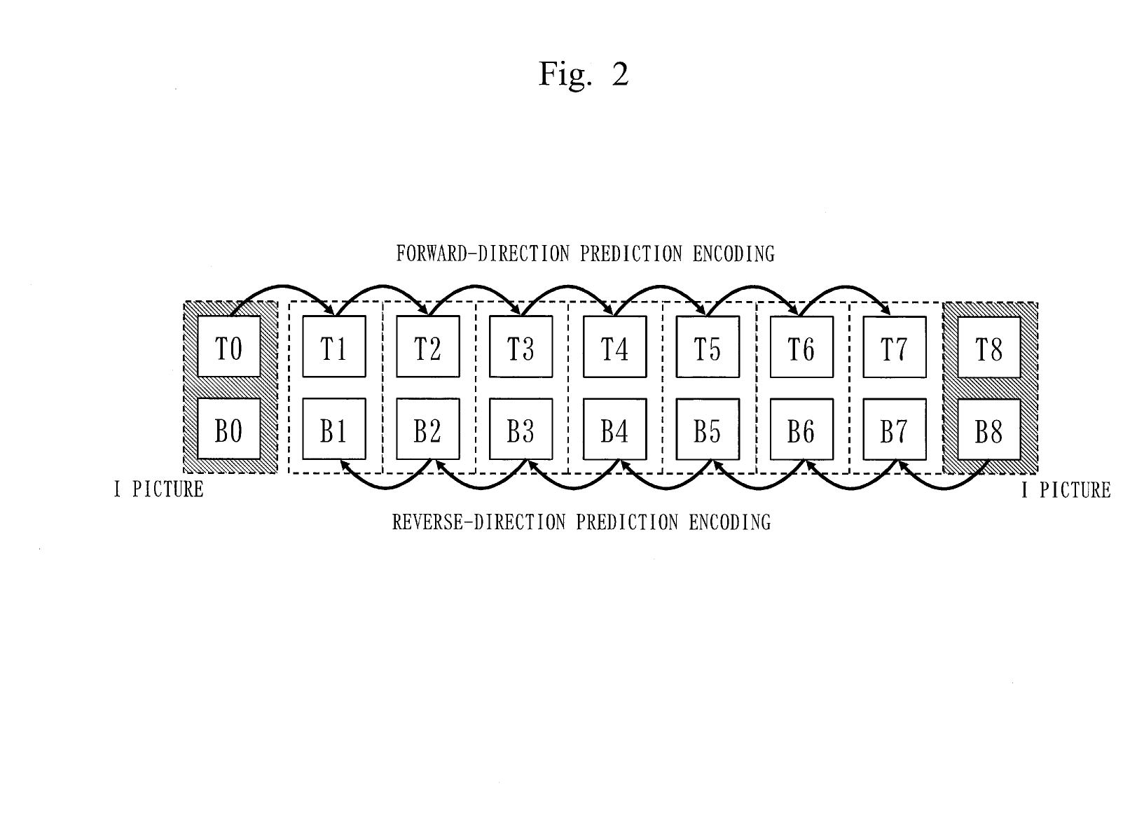

FIG. 2 is a diagram illustrating an example of the reference direction of a prediction encoded image in the image encoding apparatus according to Embodiment 1. In the encoded image illustrated in FIG. 2, 8 frames (16 fields) constitute the GOP. Referring to FIG. 2, T expresses the encoded image of a top field, B expresses the encoded image of a bottom field, and the figure expresses the display order of the picture (POC: Picture Order Count).

As illustrated in FIG. 2, the pictures of top fields T1 to T7 are subjected to inter-frame prediction encoding in the display order with using T0 as a base point and referring to the most recent top field. More specifically, after T0 is subjected to intra-frame prediction encoding as an I picture, T1 is subjected to inter-frame prediction encoding with using T0 as a reference image, and then T2 is subjected to inter-frame prediction encoding with referring to T1. Subsequent top fields T3 to T7 are sequentially subjected to inter-frame prediction encoding in the same manner. Meanwhile, bottom fields B1 to B7 are stored in the input buffer. The pictures of the bottom fields B1 to B7 are subjected to inter-frame prediction encoding in the reverse direction with respect to the display order, with using a bottom field B8 of the I picture at the head of the next GOP as a base point and referring to the immediately subsequent bottom field. More specifically, after B8 is subjected to intra-frame prediction encoding as an I picture, B7 is subjected to intra-frame prediction encoding with referring to B8, and then B6 is subjected to intra-frame prediction encoding with referring to B7. The preceding bottom fields B5 to B1 are subjected to inter-frame prediction encoding in the same manner.

In order to implement above encoding, the control unit 113 discriminates whether or not the frame of the input image signal is the frame at the head of the GOP. If the frame of the input image signal is the frame at the head of the GOP, the control unit 113 subjects this frame to intra-frame prediction encoding. If this frame is a frame other than the head of the GOP, the control unit 113 outputs to the input image buffer 101 and picture buffer 109 a control signal that causes the input image signals accumulated in the input image buffer 101 and the decoded image signals accumulated in the picture buffer 109 to be outputted or deleted, so that the top fields are encoded in the forward direction with respect to the display order and that the bottom fields are encoded in the reverse direction with respect to the display order.

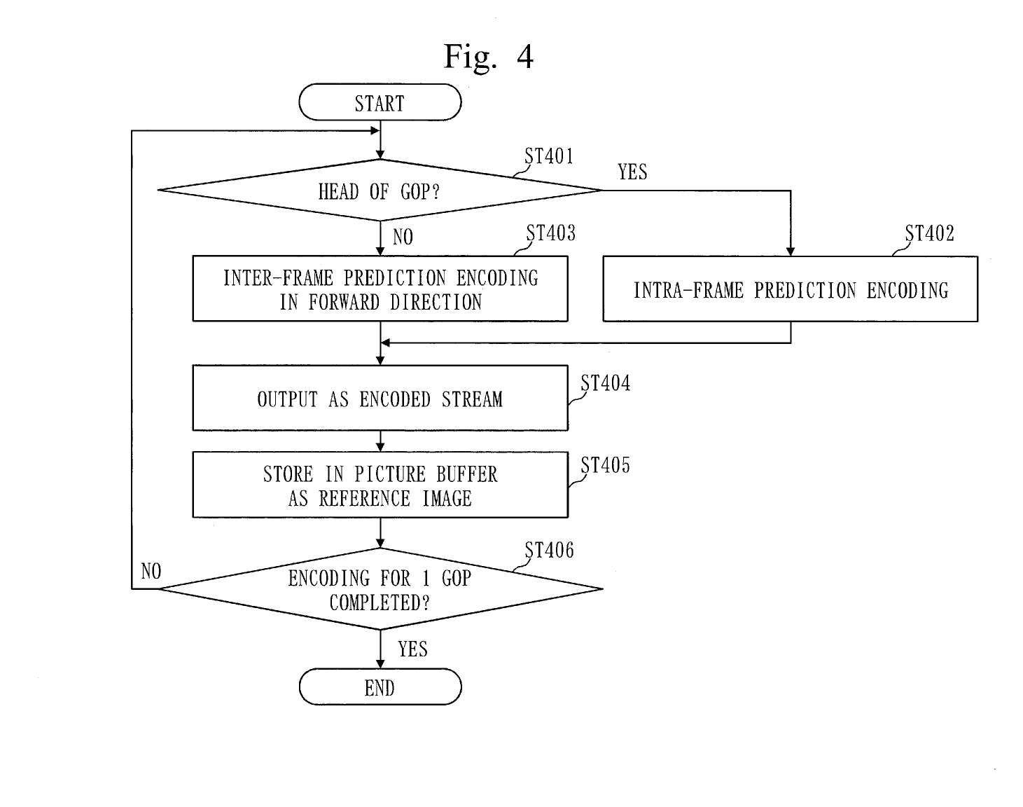

FIG. 4 is a flowchart illustrating a process stage in encoding the fields of 1 GOP in the forward direction with respect to the display order, in the image encoding apparatus according to Embodiment 1.

The control unit 113 counts the number of frames of the input image signals inputted to the image encoding apparatus, and discriminates, among the input image signals accumulated in the input image buffer 101, a picture that should be subjected to intra-frame prediction encoding as the head picture of the GOP, based on the preset number of frames constituting the GOP (step ST401). Where the picture being the head picture of the GOP is discriminated, the control unit 113 outputs to the input image buffer 101 a control signal that causes the input image signal being the head picture of the GOP to be outputted, and this input image signal is subjected to intra-frame prediction encoding (step ST402). Where input image signals are to be subjected to inter-frame prediction encoding as pictures other than the head of the GOP, the control unit 113 outputs to the input image buffer 101 a control signal that causes the input image signals constituting the top fields to be outputted in the forward direction with respect to the display order, and the input image signals are subjected to inter-frame prediction encoding (step ST403). Input images constituting the bottom fields need be encoded in the reverse direction, and are accordingly stored in the input image buffer. The input image signals encoded in the forward direction are outputted to the outside of the image encoding apparatus as an encoded stream (step ST404). The control unit 113 outputs to the picture buffer 109 a control signal that causes the decoded image signal outputted from the addition unit 108, to be stored as a reference image (step ST405). If the control unit 113 detects that the number of encoded pictures reaches the preset number of pictures constituting the GOP, the control unit 113 completes the encoding process for one GOP; if the number of pictures constituting the preset GOP is not reached yet, the control unit 113 returns to step ST401 (step ST406).

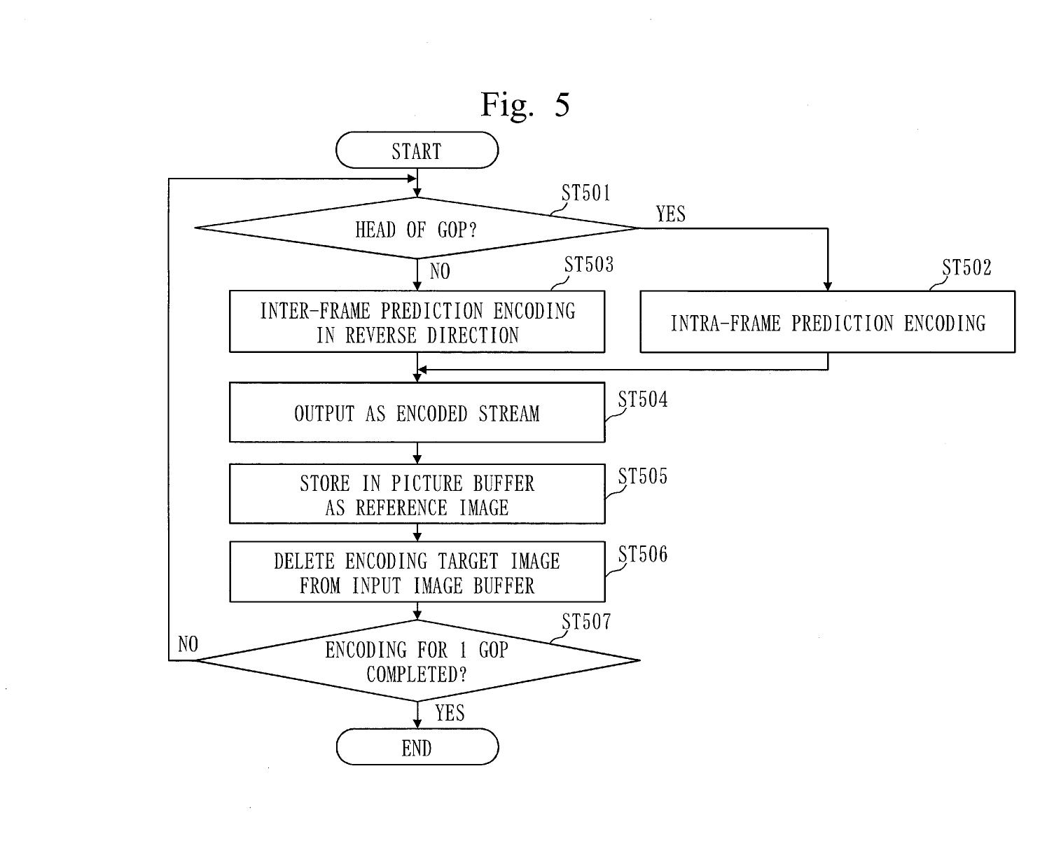

FIG. 5 is a flowchart illustrating a process stage, in the image encoding apparatus according to Embodiment 1, of when encoding the fields in 1 GOP in the reverse direction with respect to the display order.

The control unit 113 counts the number of frames of the input image signals inputted to the image encoding apparatus, and discriminates, among the input image signals accumulated in the input image buffer 101, a picture that should be subjected to intra-frame prediction encoding as the head picture of the GOP, based on the preset number of frames constituting the GOP (step ST501). Where a picture is discriminated as the head picture of the GOP, the control unit 114 outputs to the input image buffer 101 a control signal that causes the input image signal being the head picture of the GOP to be outputted, and this input image signal is subjected to intra-frame prediction encoding (step ST502). Where input image signals are to be subjected to inter-frame prediction encoding as pictures other than the head of the GOP, the control unit 113 outputs to the input image buffer 101 a control signal that causes the input image signals constituting the bottom fields to be outputted in the reverse direction with respect to the display order, and the input image signals are subjected to inter-frame prediction encoding (step ST503). The encoded input image signals are outputted to the outside of the image encoding apparatus as an encoded stream (step ST504). The control unit 113 outputs to the picture buffer 109 a control signal that causes the decoded image signal outputted from the addition unit 108, to be stored as a reference image (step ST505). After the input image signals of the bottom field are encoded in the reverse direction with respect to the display order, the control unit 113 outputs to the input image buffer 101 a control signal for deleting the input image signals of the encoding-completed fields. The input image buffer 101 deletes the input image signals of the encoding-completed fields in response to the control signal (step ST506). If the control unit 113 detects that the number of encoded pictures reaches the preset number of pictures constituting the GOP, the control unit 113 completes the encoding process for one GOP; if the number of pictures constituting the GOP is not reached yet, the control unit 113 returns to step ST501 (step ST507).

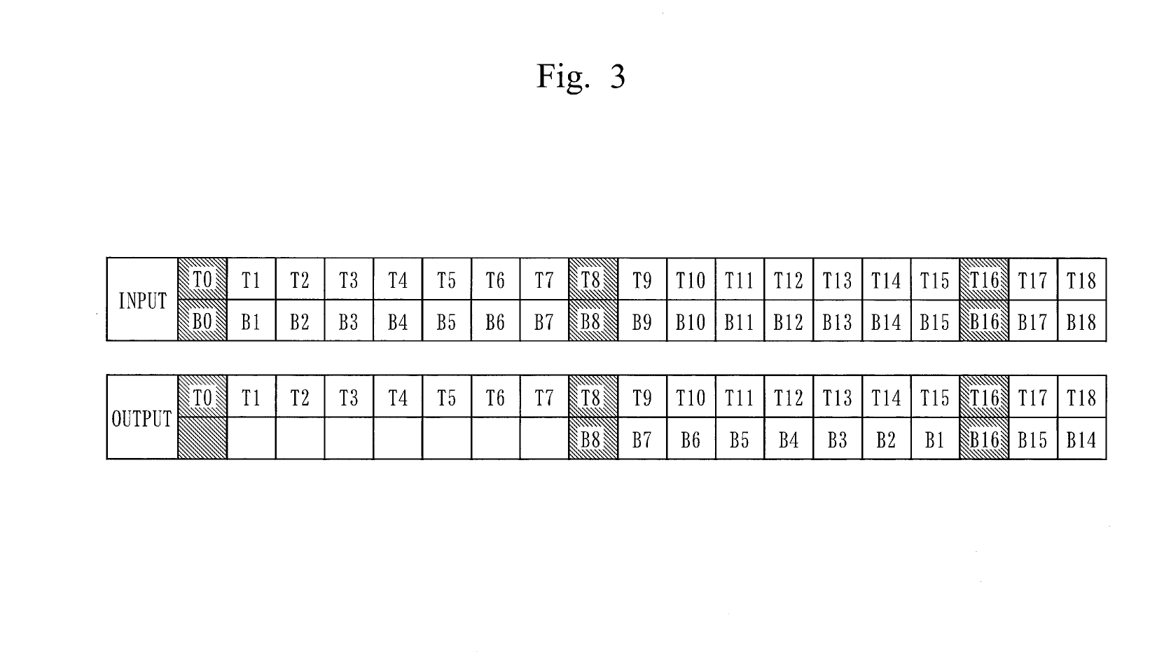

FIG. 3 is a diagram illustrating the relation between input image signals to be inputted to the image encoding apparatus according to Embodiment 1 and an encoded stream to be outputted. Referring to FIG. 3, T expresses top field, B expresses bottom field, and the figure expresses the display order (POC) of the picture (field). Halftone pictures are I pictures, and the other pictures are P pictures or B pictures. In FIG. 3, the input image signals and output image signals are inputted and outputted in the order of from the left to the right. The data of the individual fields are outputted as an encoded stream in the encoding order.

As illustrated in FIG. 3, the image encoding apparatus according to Embodiment 1 subjects the top fields T1 to T7 to inter-frame prediction encoding with using the top field T0 at the head of the first GOP as a base point and outputs them, subjects the bottom fields B1 to B7 to inter-frame prediction encoding in the reverse direction with respect to the display order with using the bottom field B8 at the head of the next GOP as the base point, and outputs the resultant bottom fields B1 to B7 together with the top fields T9 to T15 of the next GOP which are to be subjected to inter-frame prediction encoding in the forward direction.

FIG. 2 illustrates an example in which the top fields are subjected to inter-frame prediction encoding in the forward direction with respect to the display order and the bottom fields are subjected to inter-frame prediction encoding in the reverse direction with respect to the display order. The top fields may be subjected to inter-frame prediction encoding in the reverse direction with respect to the display order, and the bottom fields may be subjected to inter-frame prediction encoding in the forward direction with respect to the display order.

As described above, the image encoding apparatus according to Embodiment 1 subjects, among the pictures other than the head picture of the GOP, either the top fields or the bottom fields to inter-frame prediction encoding in the forward direction with respect to the display order, and subjects the other fields to inter-frame prediction encoding in the reverse direction. When reverse reproduction is performed, image data being subjected to inter-frame prediction encoding in the reverse direction are decoded selectively, so that the processing amount is decreased, thereby reducing the display delay.

### Embodiment 2

An image encoding apparatus according to Embodiment 2 has the same configuration as that of the image encoding apparatus according to Embodiment 1 illustrated in FIG. 1. The process stage of the encoding process in the image encoding apparatus according to Embodiment 2 is the same as the flowcharts illustrated in FIGS. 4 and 5.

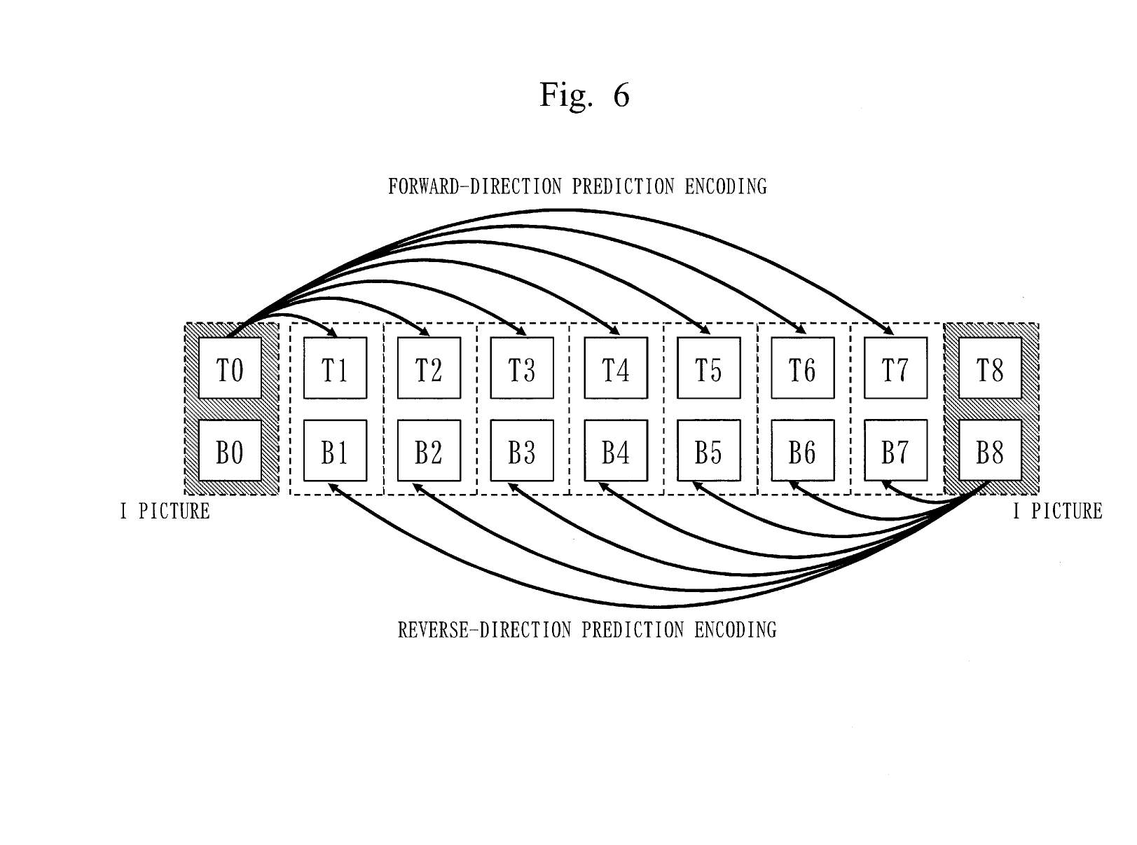

FIG. 6 is a diagram illustrating an example of a predicted image reference direction in an image encoding apparatus according to Embodiment 2.

As illustrated in FIG. 6, after T0 is subjected to intra-frame prediction encoding as an I picture, the pictures of T1 to T7 are subjected to inter-frame prediction encoding with using T0 as a reference image. Meanwhile, bottom fields B1 to B7 are stored in an input image buffer 101. The pictures of the bottom fields B1 to B7 are subjected to inter-frame prediction encoding in the display order with using, as a reference picture, a bottom field B8 at the head of the next GOP, the bottom field being to be subjected to intra-frame prediction encoding as an I picture. The encoding-process-completed bottom fields are sequentially deleted from the input image buffer 101.

In order to implement above encoding, a control unit 113 discriminates whether or not the frame of an input image signal is the frame at the head of the GOP. If the frame of the input image signal is the frame at the head of the GOP, the control unit 113 subjects this frame to intra-frame prediction encoding. If the frame of the input image signal is a frame other than the head of the GOP, the control unit 113 outputs to the input image buffer 101 and a picture buffer 109 a control signal that causes the input image signals accumulated in the input image buffer 101 and the decoded image signals accumulated in the picture buffer 109 to be outputted or deleted, so that the top fields are subjected to inter-frame prediction encoding with using the top field at the head of the GOP as a reference image, and that the bottom fields are subjected to inter-frame prediction encoding with using the bottom field at the head of the next GOP as a reference image.

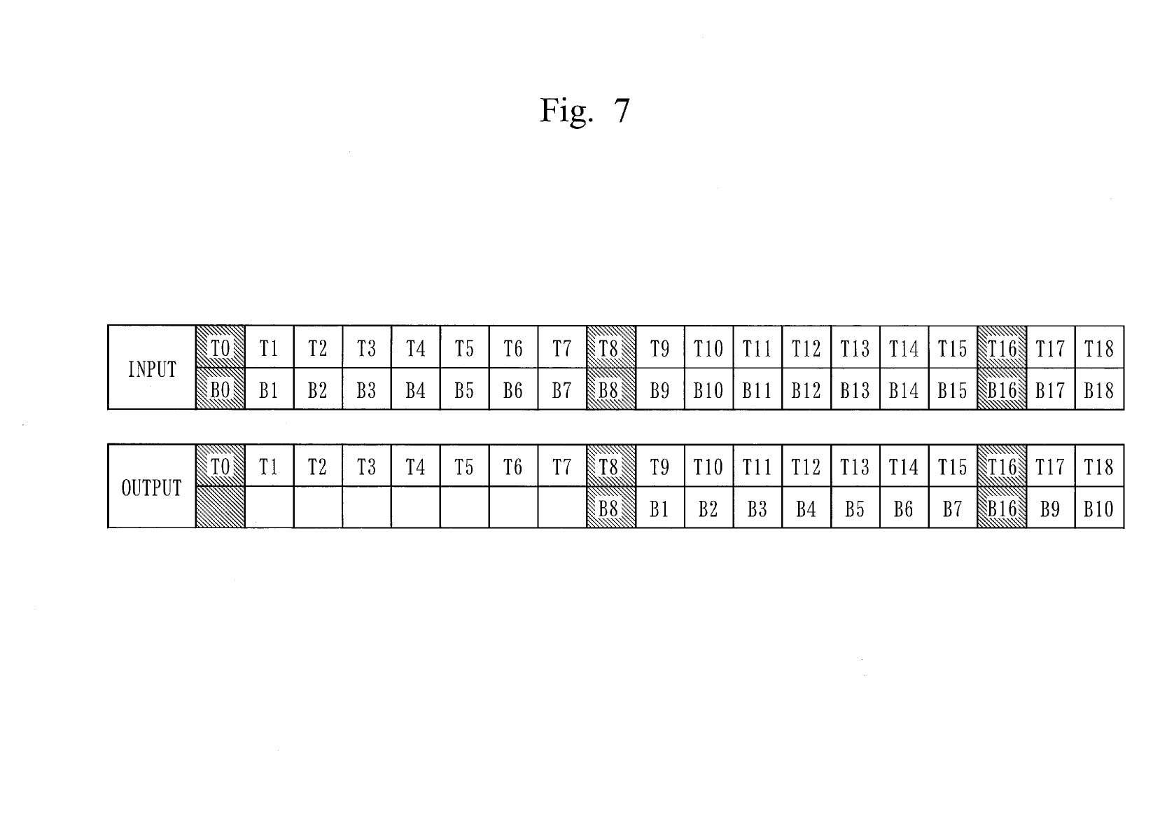

FIG. 7 is a diagram illustrating the relation between input image signals to be inputted to the image encoding apparatus according to the embodiment and an encoded stream to be outputted. As illustrated in FIG. 7, in order to reduce the decoding delay in normal reproduction (forward-direction reproduction), the bottom fields B1 to B7 being subjected to inter-frame prediction encoding are outputted in the display order. B1 is subjected to inter-frame prediction encoding with using, as a reference image, B8 being subjected to intra-frame prediction encoding. Then, B2 is subjected to inter-frame prediction encoding with using B8 as a reference image. Likewise, B3 to B7 are subjected to inter-frame prediction encoding in the display order with using B8 as a reference image, and are outputted.

FIG. 6 illustrates an example in which the top fields are subjected to inter-frame prediction encoding in the forward direction with respect to the display order and the bottom fields are subjected to inter-frame prediction encoding in the reverse direction with respect to the display order. The top fields may be subjected to inter-frame prediction encoding in the reverse direction with respect to the display order, and the bottom fields may be subjected to inter-frame prediction encoding in the reverse direction with respect to the display order.

As described above, the image encoding apparatus according to Embodiment 2 subjects, among the pictures other than the head picture of the GOP, either the top fields or the bottom fields to inter-frame prediction encoding in the forward direction with respect to the display order, subjects the other fields to inter-frame prediction encoding in the reverse direction, and outputs, in the display order, the pictures being subjected to inter-frame prediction encoding in the reverse direction. When reverse reproduction is performed, image data being subjected to inter-frame prediction encoding in the reverse direction are decoded selectively, so that the processing amount is decreased, thereby reducing the display delay, while decreasing the display delay in normal reproduction.

### Embodiment 3

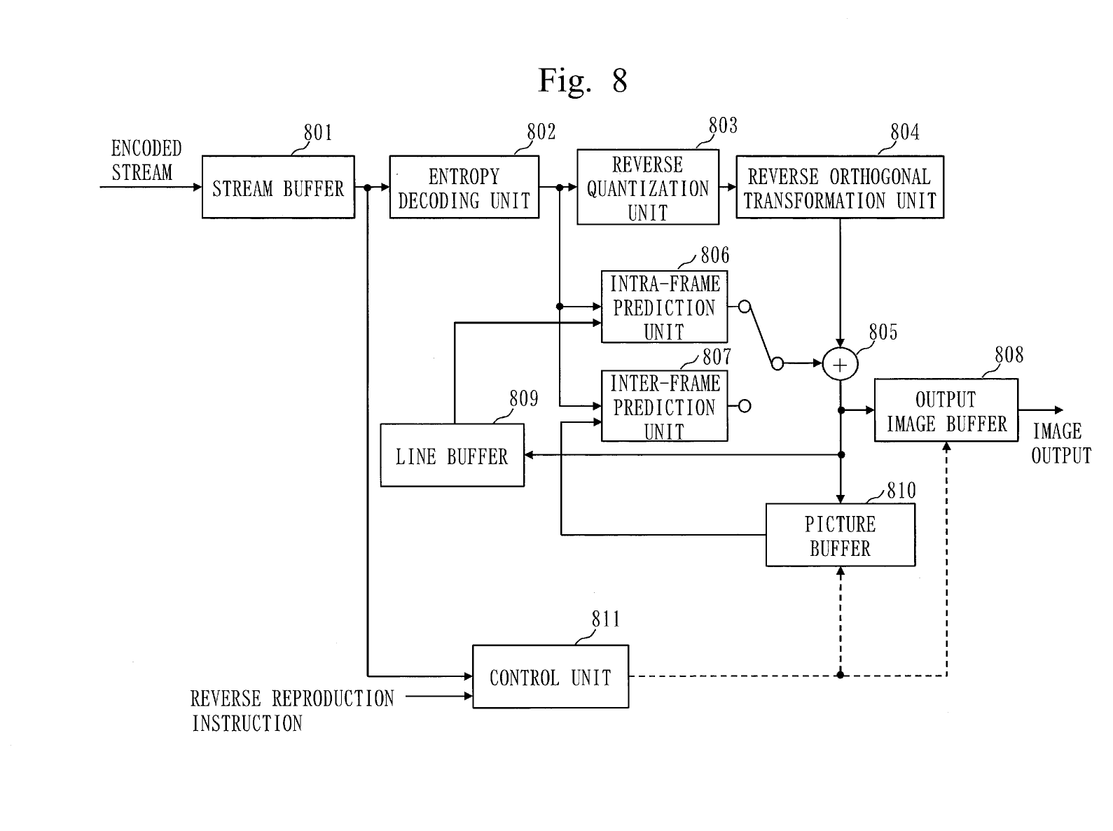

FIG. 8 is a configuration diagram illustrating an example of an image decoding apparatus according to Embodiment 3. The image decoding apparatus according to Embodiment 3 decodes an encoded stream outputted from the image encoding apparatuses according to Embodiments 1 and 2.

A stream buffer 801 accumulates the encoded stream inputted to the image decoding apparatus and outputs the encoded stream to an entropy decoding unit 802 and a control unit 811. The entropy decoding unit 802 subjects the encoded stream outputted from the stream buffer 801 to variable-length decoding, and outputs a quantization coefficient, a motion vector, reference source information, and referenced information to a reverse quantization unit 803, an intra-frame prediction unit 806, and an inter-frame prediction unit 807. The reverse quantization unit 803 subjects the quantization coefficient inputted from the entropy decoding unit 802, to reverse quantization, and outputs a decoded transformation coefficient to the reverse orthogonal transformation unit 804. The reverse orthogonal transformation unit 804 subjects the decoded transformation coefficient outputted from the reverse quantization unit 803 to reverse orthogonal transformation, and outputs a decoded difference signal to an addition unit 805. The addition unit 805 adds together the decoded difference signal outputted from the reverse orthogonal transformation unit 804 and a predicted image signal outputted from the intra-frame prediction unit 806 or inter-frame prediction unit 807, and outputs a decoded image signal to an output image buffer 808 and a picture buffer 810. The output image buffer 808 accumulates the decoded image signals outputted from the addition unit 805, and outputs the decoded image signals of the top fields and bottom fields to the outside of the frame decoding apparatus based on a control signal from the control unit 811, in accordance with the display order being set at the time of encoding.

A line buffer 809 accumulates the decoded image signals outputted from the addition unit 805 and outputs the decoded image signals which the intra-frame prediction unit 806 uses for prediction. The picture buffer 810 accumulates the decoded image signals outputted from the addition unit 805, and outputs to the inter-frame prediction unit 807 or discards the decoded image signals, based on the control signal from the control unit 811. The control unit 811 counts the input number of encoded streams inputted to the image decoding apparatus, and in response to a reverse reproduction instruction inputted from the user, outputs to the output image buffer 808 and picture buffer 810 a control signal which instructs the output image buffer 808 and the picture buffer 810 to output or delete the image signals accumulated in them. The control unit 811 also detects missing in the encoded stream, and outputs to the output image buffer 808 a control signal that causes the other fields to be outputted instead of the missing-involved fields.

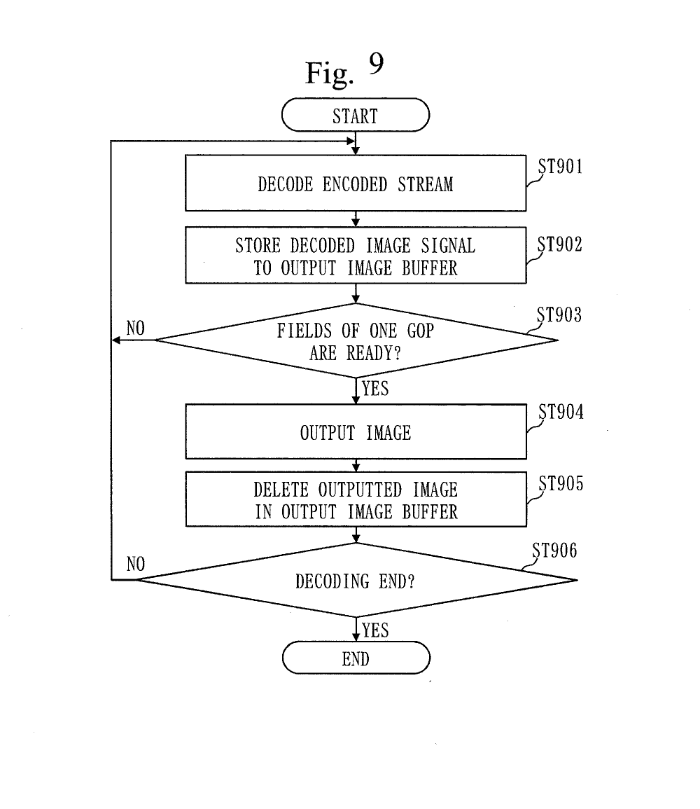

FIG. 9 is a flowchart illustrating a process in normal reproduction of the image decoding apparatus according to Embodiment 3. The inputted encoded stream is decoded (step ST901) and accumulated in the output image buffer 808 (step ST902). When the encoded stream illustrated in FIG. 3 is inputted, the pictures of the bottom fields are inputted to the image decoding apparatus in the reverse order with respect to the display order, because the pictures of the bottom fields have been encoded in the reverse direction with respect to the display order, as illustrated in FIG. 2. The output image buffer 808 accumulates the decoded image signals of the bottom fields, rearranges the decoded images of the top fields being encoded in the display order to form a pair, and outputs the rearranged decoded images. The control unit 811 counts the input number of encoded streams outputted from the stream buffer 801 and checks whether or not the top fields and corresponding bottom fields of one GOP can be outputted (step ST903). If such fields can be outputted, the images are outputted from the output image buffer 808 in the display order (step ST904). If such fields cannot be outputted, the process returns to step ST901 and the next field is decoded. The outputted images are deleted from the output image buffer 808 (step ST905). When a decoding end instruction is sent from the user, the decoding process described above ends (step ST906).

When the control unit 811 detects missing in the inputted encoded stream, as the top fields and the bottom fields are encoded independently of each other, displaying can be continued by using decoded image signals of missing-free fields instead of the decoded image signals of the missing-involved fields. The control unit 811 outputs to the output image buffer 808 a control signal that causes the data of the other fields to be outputted instead of the missing-involved fields. For example, in the encoding method illustrated in FIG. 2, if the top field T3 is missing, the top fields T4 to T7 cannot be decoded. However, displaying can be continued by using the bottom fields B4 to B7 instead. In the encoding method illustrated in FIG. 6, if the bottom field B8 serving as a reference image is missing, the bottom fields B1 to B7 cannot be decoded. However, displaying can be continued by using the top fields T0 to T7 instead.

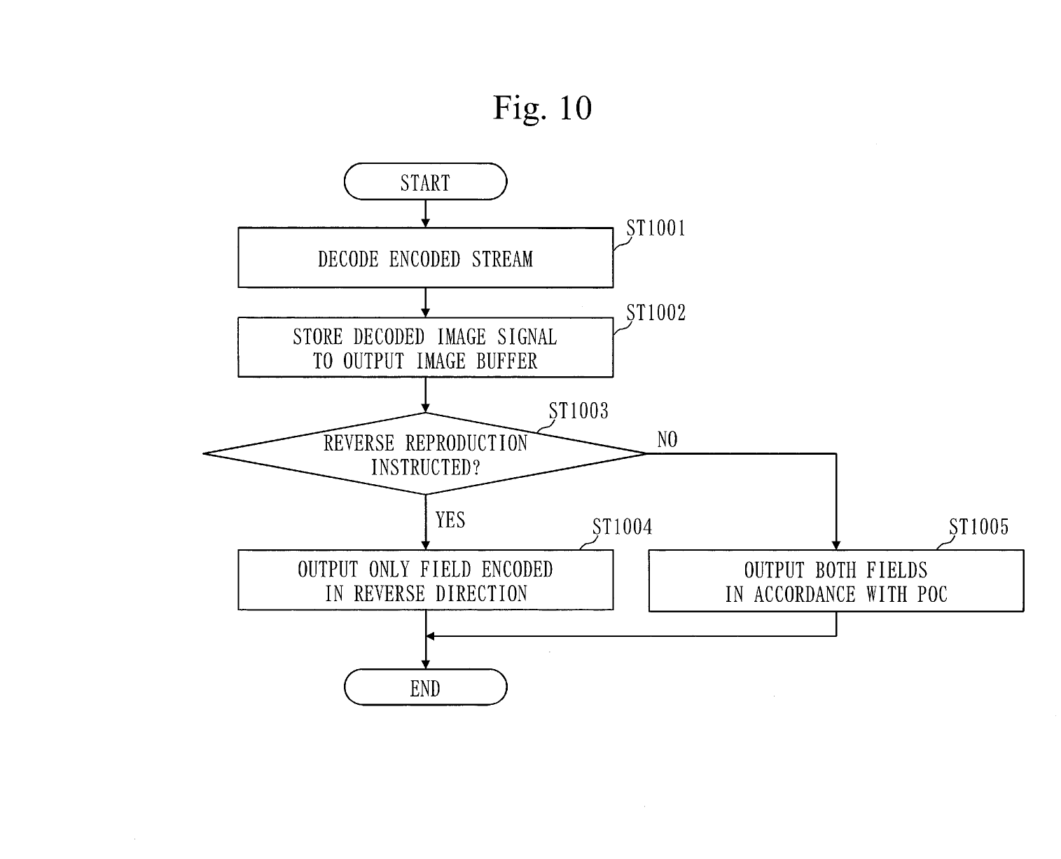

FIG. 10 is a flowchart illustrating a process in reverse reproduction of the image decoding apparatus according to Embodiment 3. The inputted encoded stream is decoded (step ST1001) and accumulated in the output image buffer 808 (step ST1002). If a reverse-direction reproduction instruction has been inputted to the control unit 811, the control unit 811 outputs to the output image buffer 808 a control signal that causes only a field encoded in the reverse direction with respect to the display order to be outputted (step ST1003). The control unit 811 also outputs to the output image buffer 808 a control signal that causes fields encoded in the reverse direction to be outputted instead of fields not to be displayed, which are encoded in the forward direction. When the control signal for reverse reproduction is outputted from the control unit 811, the output image buffer 808 outputs only fields being encoded in the reverse direction with respect to the display order (step ST1004). If an instruction for reverse reproduction is not given, the output image buffer 808 outputs the top fields and the bottom fields in the display order (POC) in the same manner as in the process of the flowchart illustrated in FIG. 9 (step ST1005).

As described above, in reverse-direction reproduction, only fields being encoded in the reverse direction with respect to the display order are decoded and outputted instead of the fields being encoded in the forward direction, so that the decoding process in reverse reproduction can be reduced.

In normal reproduction, field decoded image signals being encoded in the reverse direction with respect to the display order are accumulated, the decoded images of the fields being encoded in the display order are rearranged to form a pair, and the rearranged decoded images are outputted. As a result, the decoded image signals can be outputted according to the display order.

Furthermore, the top fields and the bottom fields are decoded independently of each other. If missing occurs in some field, displaying can be continued by using missing-free fields instead of the missing-involved fields.

### Embodiment 4

An image encoding apparatus according to Embodiment 4 has the same configuration as that of the image encoding apparatus according to Embodiment 1.

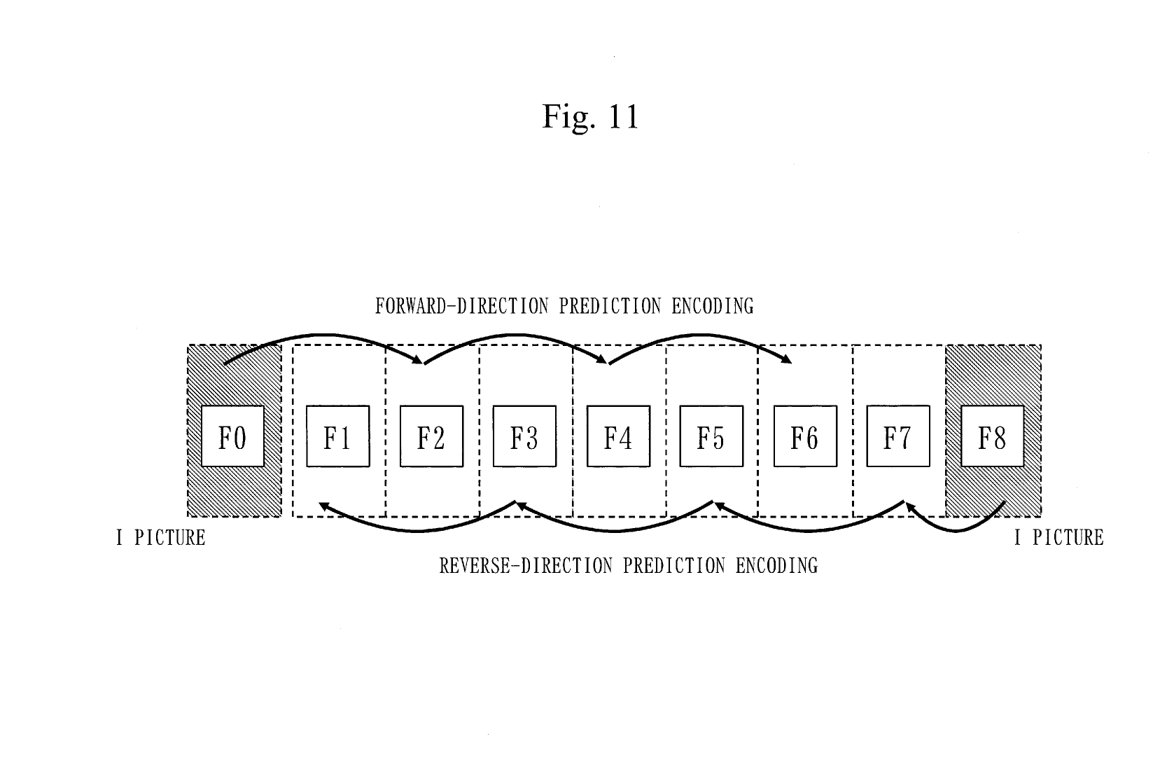

FIG. 11 is a diagram illustrating a reference direction of a prediction image in the image encoding apparatus according to Embodiment 4. In the encoded image illustrated in FIG. 11, 8 frames constitute the GOP. Referring to FIG. 11, F expresses the frame, the figure expresses POC, and a halftone portion expresses an I frame (a frame being subjected to intra-frame prediction encoding).

As illustrated in FIG. 11, with the image encoding apparatus according to Embodiment 4, among frames constituting the GOP, even-number frames are encoded in the forward direction with respect to the display order and odd-number frames are encoded in the reverse direction with respect to the display order. After a frame F0 is subjected to intra-frame prediction encoding, F2 is subjected to inter-frame prediction encoding with using F0 as a reference image. Then, F4 is subjected to inter-frame prediction encoding with using F2 as a reference image, and F6 is subjected to inter-frame prediction encoding likewise. Meantime, odd-number frames F1, F3, F5, and F7 are stored in an input image buffer 101. After a head frame F8 of the next GOP is subjected to intra-frame prediction encoding, odd-number frames F1, F3, F5, and F7 are subjected to inter-frame prediction encoding in the reverse direction with respect to the display order, with using F8 as a base point. More specifically, as illustrated in FIG. 11, F7 is subjected to inter-frame prediction encoding with using F8 as a reference image. Then, F5 is subjected to inter-frame prediction encoding with using F7 as a reference image, and F3 and F1 are subjected to inter-frame prediction encoding likewise.

In order to implement above encoding, a control unit 113 discriminates whether or not the frame of an input image signal is the frame at the head of the GOP. If the frame of the input image signal is the frame at the head of the GOP, the control unit 113 subjects this frame to intra-frame prediction encoding. If this frame is a frame other than that at the head of the GOP, the control unit 113 outputs to the input image buffer 101 and a picture buffer 109 a control signal that causes the input image signals accumulated in the input image buffer 101 and the decoded image signals accumulated in the picture buffer 109 to be outputted or deleted, so that the even-number frames are encoded in the forward direction and that the odd-number frames are encoded in the reverse direction.

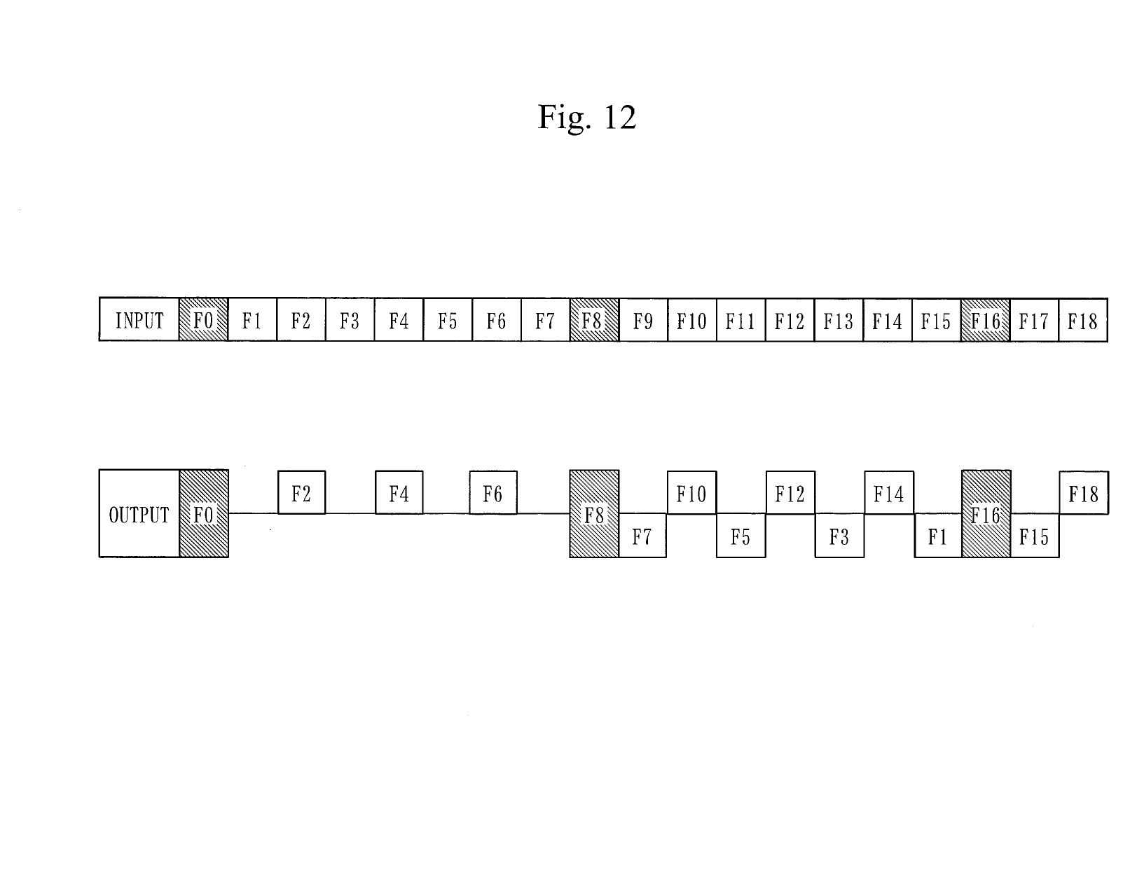

FIG. 12 is a diagram illustrating the relation between input image signals to be inputted to the image encoding apparatus according to Embodiment 4 and an encoded stream to be outputted. Referring to FIG. 12, F expresses frame and the figure expresses the display order (POC). Halftone pictures are I pictures, and the other pictures are P pictures or B pictures. As illustrated in FIG. 12, the even-number frames are outputted according to POC, and the odd-number frames are outputted in the reverse order to that of POC to alternate with the even-number frames.

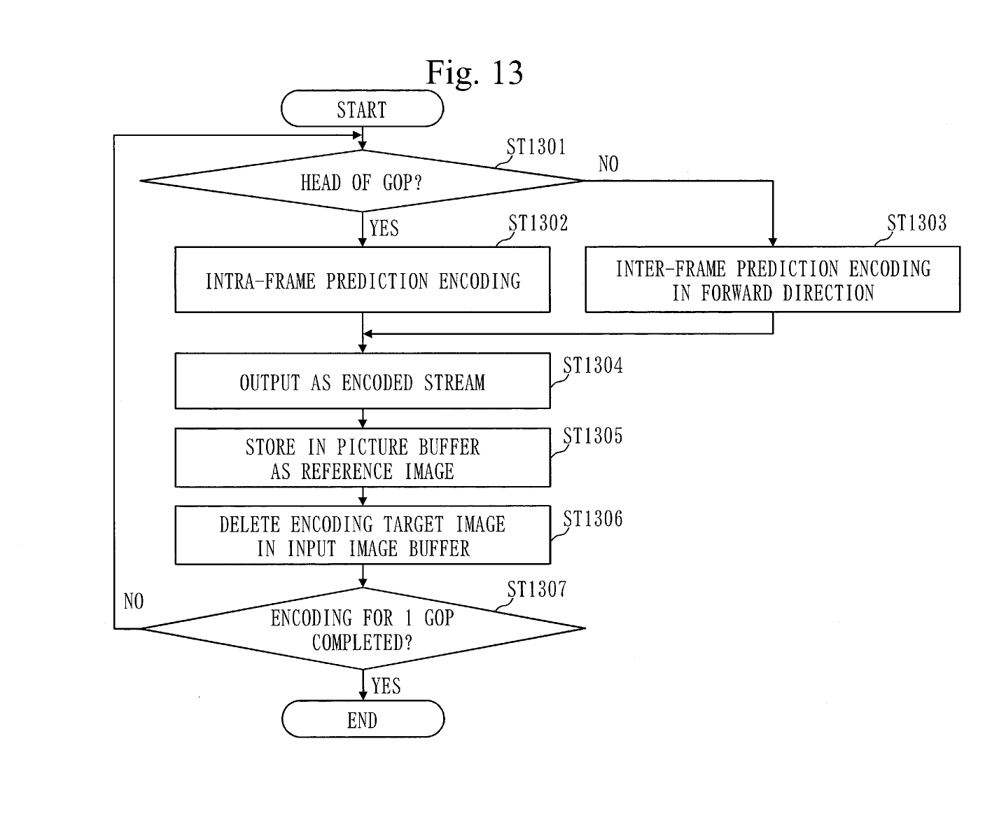

FIG. 13 is a flowchart illustrating a process stage in encoding even-number frames of 1 GOP in the mage encoding apparatus according to Embodiment 4.

The control unit 113 counts the frame of the input image signal inputted to the image encoding apparatus and checks whether or not the input image signal is to be subjected to intra-frame prediction encoding as the head frame of the GOP, based on the preset number of frames constituting the GOP (step ST1301). Where the input image signal is determined as the head frame of the GOP, the control unit 113 outputs to the input image buffer 101 a control signal that causes the input image signal being the head frame to be outputted, and this input image signal is subjected to intra-frame prediction encoding (step ST1302). The control unit 113 outputs to the input image buffer 101 a control signal that causes the input image signals of even-number frames, out of frames other than the head frame of the GOP, to be outputted in the forward direction with respect to the display order, and the input image signals are subjected to an inter-frame prediction encoding process (step ST1303). The encoded input image signals are outputted to the outside of the image encoding apparatus as an encoded stream (step ST1304). In order to perform inter-frame prediction encoding with using the most recently encoded frame as a reference image, the control unit 113 outputs a control signal that causes a decoded image signal outputted from an addition unit 108, to be stored in the picture buffer 109 as a reference image (step ST1305). The control unit 113 outputs to the input image buffer 101 a control signal that causes the input image signal for which the encoding process has been completed, to be deleted, and the input image buffer 101 deletes the input image signal in response to the control signal (step ST1306). If the control unit 113 detects that the number of encoded frames reaches the number of even-number frames constituting the GOP, the encoding process for 1 GOP is completed; if the number of even-number frames constituting the GOP is not reached yet, the process returns to step ST1301 (step ST1307).

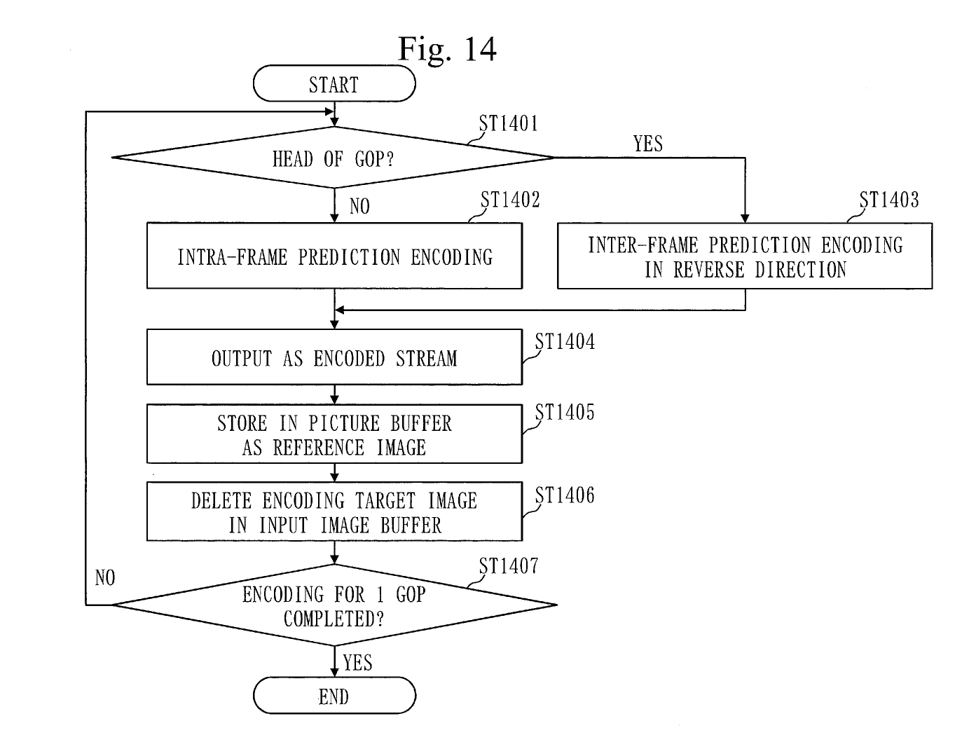

FIG. 14 is a flowchart illustrating a process stage in encoding odd-number frames of 1 GOP in the mage encoding apparatus according to Embodiment 4.

The control unit 113 counts the frame of the input image signal inputted to the image encoding apparatus and checks whether or not the input image signal is to be subjected to intra-frame prediction encoding as the head frame of the GOP, based on the preset number of frames constituting the GOP (step ST1401). Where the input image signal is determined as the head frame of the GOP, the control unit 113 outputs to the input image buffer 101 the input image signal being the head frame, and subjects this input image signal to intra-frame prediction encoding (step ST1402). The control unit 113 outputs to the input image buffer 101 a control signal that causes the input image signals of odd-number frames, among frames other than the head frame of the GOP, to be outputted in the reverse direction with respect to the display order, and the input image signals are subjected to an inter-frame prediction encoding process (step ST1403). The encoded input image signals are outputted to the outside of the frame decoding apparatus as an encoded stream (step ST1404). In order to perform inter-frame prediction encoding with using the most recently encoded frame as a reference image, the control unit 113 outputs a control signal that causes a decoded image signal outputted from an addition unit 108, to be stored in the picture buffer 109 as a reference image (step ST1405). The control unit 113 outputs to the input image buffer 101 a control signal that causes the input image signal for which the encoding process has been completed, to be deleted, and the input image buffer 101 deletes the input image signal in response to the control signal (step ST1406). If the control unit 113 detects that the number of encoded frames reaches the number of odd-number frames constituting the GOP, the encoding process for 1 GOP is completed; if the number of odd-number frames constituting the GOP is not reached yet, the process returns to step ST1401 (step ST1407).

FIG. 11 illustrates an example where the even-number frames are encoded in the display order and the odd-number frames are encoded in the reverse direction with respect to the display order. The odd-number frames may be encoded in the display order and the even-number frames may be encoded in the reverse direction with respect to the display order.

As described above, regarding progressive-method image data, the image encoding apparatus according to Embodiment 4 subjects, among the pictures other than the head picture of the GOP, either the odd-number frames or the even-number frames to inter-frame prediction encoding in the forward direction, and subjects the other frames to inter-frame prediction encoding in the reverse direction with respect to the display order. When reverse reproduction is performed, image data being subjected to inter-frame prediction encoding in the reverse direction are decoded selectively, so that the processing amount is decreased, thereby reducing the display delay.

### Embodiment 5

An image encoding apparatus according to Embodiment 5 has the same configuration as that of the image encoding apparatus according to Embodiment 1 illustrated in FIG. 1. The process stage of the encoding process in the image encoding apparatus is the same as the flowcharts illustrated in FIGS. 13 and 14.

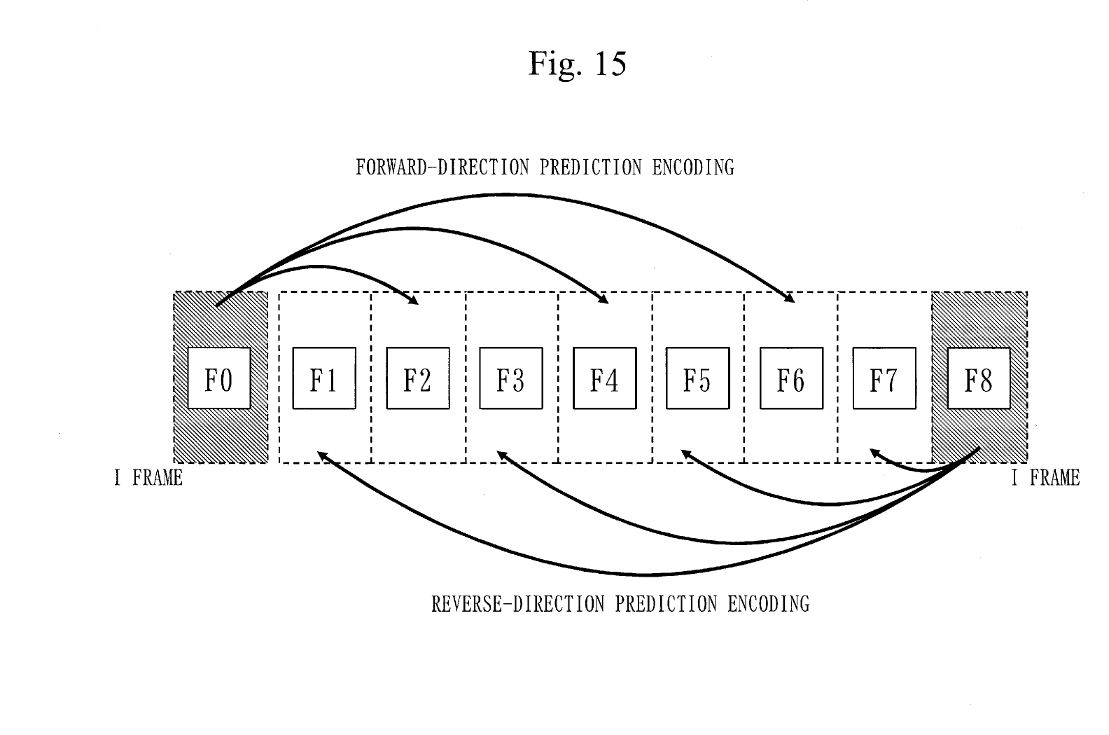

FIG. 15 is a diagram illustrating the reference direction of a prediction image in the image encoding apparatus according to Embodiment 5. As illustrated in FIG. 15, after a head frame F0 of a GOP is subjected to intra-frame prediction encoding as an I frame, even-number frames F2, F4, and F6 are subjected to inter-frame prediction encoding with using F0 as a reference image. Meantime, odd-number frames F1, F3, F5, and F7 are stored in an input image buffer 101. After a head frame F8 of the next GOP is subjected to inter-frame prediction encoding, odd-number frames F1, F3, F5, and F7 are subjected to inter-frame prediction encoding with using F8 as a reference image.

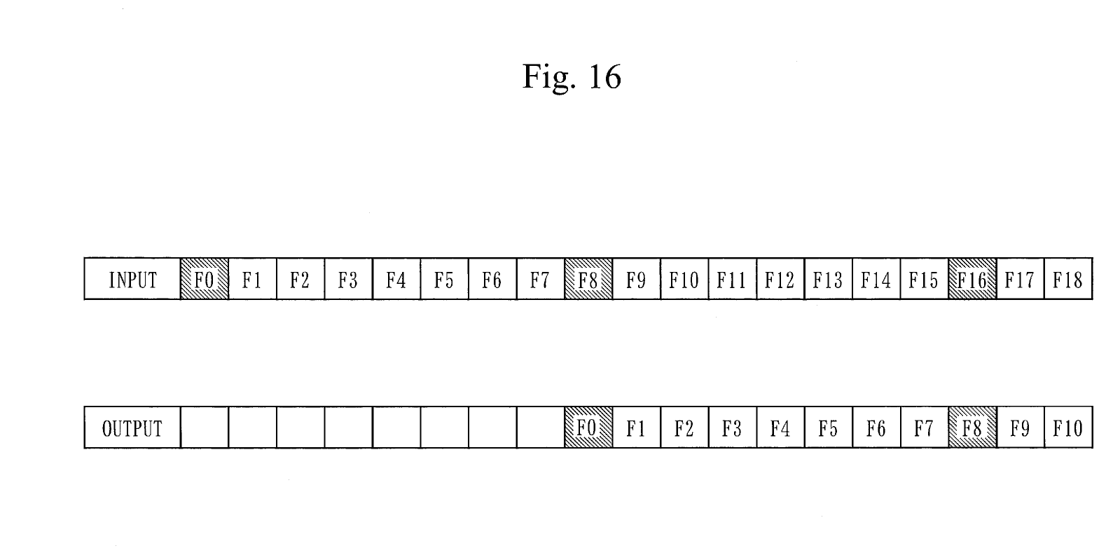

FIG. 16 is a diagram illustrating the relation between input image signals to be inputted to the image encoding apparatus according to Embodiment 4 and an encoded stream to be outputted. As illustrated in FIG. 16, in order to reduce delay in decoding, the odd-number fields F1, F3, F, 5, and F7 which have been subjected to inter-frame prediction encoding in the reverse direction with respect to the display order are outputted in the display order.

In order to implement above encoding, a control unit 113 discriminates whether or not the frame of an input image signal is the frame at the head of the GOP. If the frame of the input image signal is the frame at the head of the GOP, the control unit 113 subjects this frame to intra-frame prediction encoding. If this frame is a frame other than that at the head of the GOP, the control unit 113 outputs to the input image buffer 101 and a picture buffer 109 a control signal that causes the input image signals accumulated in the input image buffer 101 and the decoded image signals accumulated in the picture buffer 109 to be outputted or deleted, so that the even-number frames are subjected to inter-frame prediction encoding with using the frame at the head of the GOP as a reference frame and that the odd-number frames are subjected to inter-frame prediction encoding with using the frame at the head of the next GOP as a reference frame.

In FIG. 15, the even-number frames are encoded in the forward direction with using the head frame of the GOP as a reference image, and the odd-number frames are encoded in the reverse direction with respect to the display order with using the head frame of the next GOP as a reference image. The odd-number frames may be encoded in the forward direction and the even-number frames may be encoded in the reverse direction.

As described above, regarding progressive-method image data, the image encoding apparatus according to Embodiment 1 subjects, among the pictures other than the head picture of the GOP, either the odd-number frames or the even-number frames to inter-frame prediction encoding in the forward direction with respect to the display order, subjects the other frames to inter-frame prediction encoding in the reverse direction, and outputs, in the display order, the pictures being subjected to inter-frame prediction encoding in the reverse direction. When reverse reproduction is performed, image data being subjected to inter-frame prediction encoding in the reverse direction are decoded selectively, so that the processing amount is decreased, thereby reducing the display delay in normal reproduction.

### Embodiment 6

An image decoding apparatus according to Embodiment 6 has the same configuration as that of the image decoding apparatus according to Embodiments 3 illustrated in FIG. 8. The image decoding apparatus according to Embodiment 6 decodes an encoded stream outputted from the image encoding apparatuses according to Embodiments 4 and 5.

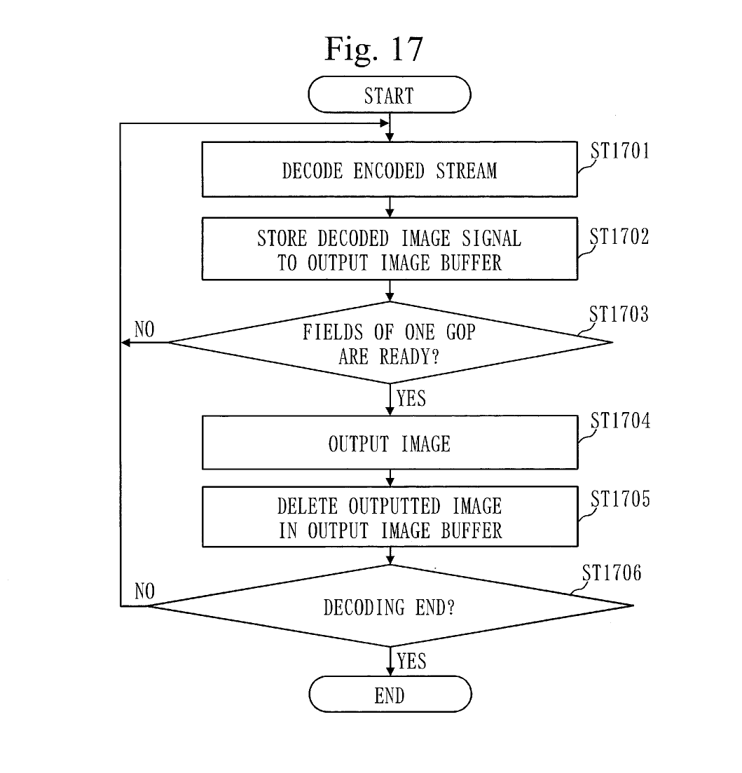

FIG. 17 is a flowchart illustrating a process in normal reproduction of the image decoding process according to Embodiment 6. An inputted encoded stream is decoded (step ST1701) and stored in an output image buffer 808 (step ST1702). Of the encoded stream illustrated in FIG. 12, odd-number frames are inputted in the reverse order with respect to the display order. The output image buffer 808 accumulates the decoded image signals of the even-number frames until the decoding process of the odd-number frames is completed, so that the order of the output images is adjusted. A control unit 811 counts the input number of encoded streams outputted from a stream buffer 801 and checks whether or not frames of 1 GOP can be outputted (step ST703). If frames of 1 GOP can be outputted, the images are outputted from the output image buffer 808 in the display order (step ST1704). If frames of 1 GOP cannot be outputted, the flow returns to step ST1701 and the next frame is decoded. The outputted images are deleted from the output image buffer 808 (step ST1705). If there is a decoding end instruction from the user, the decoding process described above ends (step ST1706).

When the control unit 811 detects missing in the inputted encoded stream, as the even-number frames and odd-number frames have been encoded independently of each other, the decoded image signals of missing-free frames can be used instead of the missing-involved frames. The control unit 811 outputs to the output image buffer 808 a control signal that causes frames before and after the missing frame to be outputted. For example, in the encoding method illustrated in FIG. 11, if the even-number frame F2 is missing, F4 and F6 cannot be decoded. By using odd-number frames F3, F5 and F7 instead, displaying can be continued.

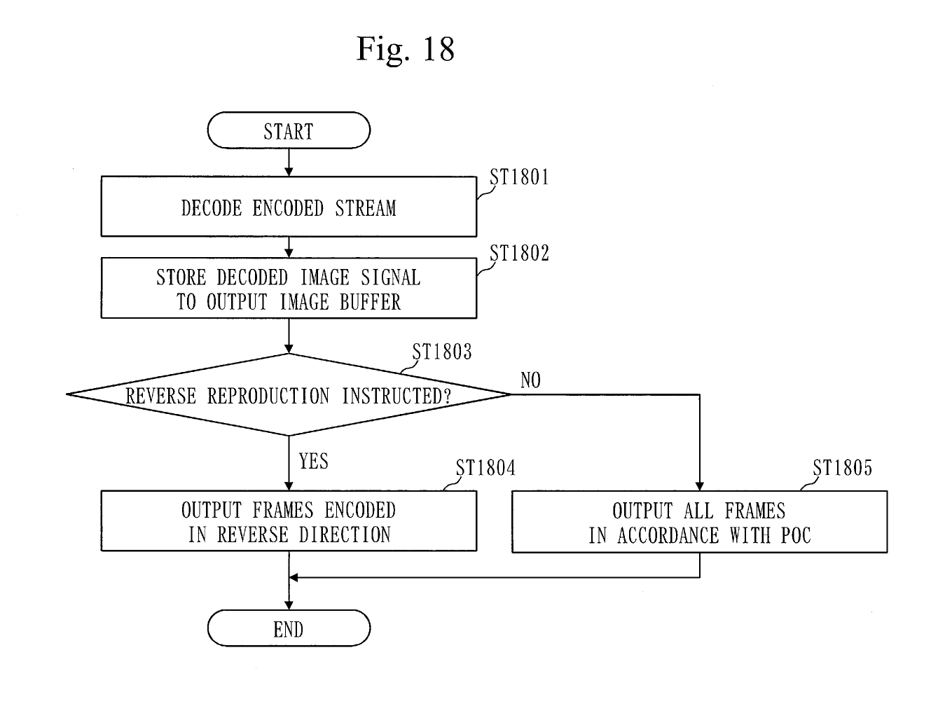

FIG. 18 is a flowchart illustrating a process in reverse reproduction of the image decoding apparatus according to Embodiment 6. An inputted encoded stream is decoded (step ST1801) and accumulated in the output image buffer 808 (step ST1802). Where a reverse-direction reproduction instruction is inputted to the control unit 811 (step ST1803), the control unit 811 outputs to the output image buffer 808 a control signal that causes only a frame being subjected to inter-frame prediction encoding in a reverse direction with respect to the display order, to be outputted (step ST1804). If encoded image data illustrated in FIG. 15 is inputted, a control signal that causes only an odd-number frame to be outputted to the output image buffer 808. The control unit 811 also outputs to the output image buffer 808 a control signal that causes frames being encoded in the reverse direction to be outputted instead of the frames not to be displayed, which are encoded in the forward direction with respect to the display order. Where the control signal for reverse reproduction is outputted from the control unit 811, the output image buffer 808 outputs only frames being encoded in the reverse direction (step ST1804). If there is no instruction for reverse reproduction, the control unit 811 outputs to the output image buffer 808 a control signal that causes images to be outputted in the display order (POC) in the same manner as in the process of normal reproduction (step ST1805).

As described, in reverse-direction reproduction, by decoding and outputting only frames being encoded in the reverse direction with respect to the display order, the decoding process in reverse reproduction can be decreased.

In normal reproduction, decoded image signals of the frames being encoded in the reverse direction with respect to the display order are accumulated. The accumulated decoded image signals are rearranged together with the decoded images of the frames being encoded in the display order, and the rearranged decoded image signals are outputted. Therefore, the decoded image signals can be outputted in the display order.

The odd-number frames and even-number frames are decoded independently of each other. Hence, even if missing occurs in some frame, displaying can be continued by using missing-free frames instead of missing-involved frames.

### REFERENCE SIGNS LIST

101: input image buffer; 102: addition unit; 103: orthogonal transformation unit; 104: quantization unit; 105: entropy encoding unit; 106: reverse quantization unit; 107: reverse orthogonal transformation unit; 108: addition unit; 109: picture buffer; 110: intra-frame prediction unit; 111: inter-frame prediction unit; 112: line buffer; 113: control unit; 801: stream buffer; 802: entropy decoding unit; 803: reverse quantization unit; 804: reverse orthogonal transformation unit; 805: addition unit; 806: intra-frame prediction unit; 807: inter-frame prediction unit; 808: output image buffer; 809: line buffer; 810: picture buffer; 811: control unit

1-10. (canceled)

11. An image encoding apparatus which encodes pictures constituted of top fields and bottom fields, comprising:
input image accumulating means for accumulating input images formed of a series of the pictures; and
encoding means for subjecting, among the input images outputted from the input image accumulating means, a head picture of a picture group formed of a predetermined number of pictures to intra-frame prediction encoding and the other pictures to inter-frame prediction encoding;
the encoding means serving to subject either the top fields or the bottom fields which constitute pictures other than the head picture, to inter-frame prediction encoding in a forward direction with respect to a display order, and the other fields to inter-frame prediction encoding in a reverse direction with respect to the display order.

12. The image encoding apparatus according to claim 11, wherein the encoding means, when performing inter-frame prediction encoding in the forward direction with respect to the display order, uses a field immediately preceding an encoding target field as a reference image, and when performing inter-frame prediction encoding in the reverse direction with respect to the display order, uses a field immediately subsequent to the encoding target field as a reference image.

13. The image encoding apparatus according to claim 11, wherein the encoding means, when performing inter-frame prediction encoding in the forward direction with respect to the display order, uses a field that constitutes the head picture of the picture group as a reference image, and when performing inter-frame prediction encoding in the reverse direction with respect to the display order, uses a field that constitutes a head picture of a picture group subsequent to the picture group as a reference image.

14. An image decoding apparatus which decodes encoded images of pictures constituted of top fields and bottom fields, comprising:
decoding means for decoding, among encoded images of the top fields and encoded images of the bottom fields, encoded images of fields being encoded in a forward direction with respect to a display order, and encoded images of fields being encoded in a reverse direction with respect to the display order;
decoded image accumulating means for accumulating decoded images decoded by the decoding means; and
control means for outputting a control signal so that the decoded images accumulated in the decoded image accumulating means are outputted in a predetermined order,
wherein when a reverse reproduction instruction is inputted, the control means outputs to the decoded image accumulating means a control signal that causes the decoded images of the fields being encoded in the reverse direction with respect to the display order, to be selected and outputted, and the decoded image accumulating means outputs the accumulated decoded images in response to the control signal.

15. The image decoding apparatus according to claim 14, wherein when missing occurs in a field on one side of the encoded images, the control means outputs to the decoded image accumulating means a control signal that causes a decoded image of a field on the other side where missing does not occur, to be outputted instead of the field where the missing occurs.
